(19) United States
(12) Patent Application Publication
(10) Pub. No.: US 2008/0078895 A1
(43) Pub. Date: Apr. 3, 2008

(54) HANDLE SECURING DEVICE

(76) Inventor: Michael Hebert, Kerrville, TX (US)

Correspondence Address: ADVANTIA LAW GROUP, 9035 SOUTH 1300 EAST, SUITE 200, SANDY, UT, 84094, US

(21) Appl. No.: 11/531,904

(22) Filed: Sep. 14, 2006

(51) Int. Cl. F16B 47/00

(52) U.S. Cl. 248/205.5; 248/316.8

(57) ABSTRACT

A handle securing device for securing handles of pots and pans. There is: a base member. Coupled to the base member are: a first vertical barrier member; a second vertical barrier member; and an attachment mechanism. The attachment mechanism includes a suction cup. The first and second vertical barrier members are substantially rigid, substantially curved, and substantially identical. The first vertical barrier member is removably coupled to the base member at a first attachment port; and the second vertical barrier member is removably coupled to the base member at a second attachment port. There is: a third vertical barrier member, removably coupleable to the first attachment port; and a fourth vertical barrier member, removably coupleable to the second attachment port.

### BACKGROUND OF THE INVENTION

1. Field of the Invention

The present invention relates to handle securing devices, specifically handle securing devices for securing handles of pots and pans.

2. Description of the Related Art

In the related art, it has been known to use handle securing devices to position and secure handles of pots and pans. In particular, it has been known to use a pot and/or pan handle securing device being adapted to securely fasten to a stove. It has also been known that the pot and/or pan handle securing device may be adjustable and may include fastening members.

It is desirable to provide safer conditions around stoves for children. Handles of pots and pans which protrude over the edge of a stove-top may be unintentionally gripped, knocked, snagged, and/or tipped by children and/or other persons in the stovetop vicinity. Accidental disruption of a handle of a pot and/or pan during cooking may result in spilling the contents of the pot and/or pan which may cause burns on a person, messes in the kitchen, and make the contents of the pot and/or pan inedible.

It is therefore desirable to position and secure handles of pots and pans to stovetops. In addition, it is desirable to position and secure handles of pots and pans away from an edge of a stovetop in order to minimize accessibility by children, accidental spilling, and/or burning. Accordingly, there is a need for a handle securing device for locking a handle into place which is adjustable, removeable, sturdy, economical and/or easy to use. Some improvements have been made in the field. Examples include but are not limited to the references described below, which references are incorporated by reference herein:

U.S. Pat. No. 6,672,550, issued to Borodulin et al., discloses a universal pan and pot lid holder. A universal pot and pan lid holder is composed of two cylindrical segments having through aligned circular slots and radial outward projections. The projection of one of the segments passes through the circular slot of the other segment and vise verse. The side edges of the cylindrical segments, which face each other, define an opening between them for access to the interior of the holder. In an assembled state of the segments they form a substantially cylindrical body with open ends and an access opening in the side of the body, so that the holder can rest on a support surface with its lower edge and provide the upper edge for temporary supporting port or pan covers or lids during cooking. The diameter of the cylindrical body should be smaller than the diameter of the lids to be supported. The segments have recesses in the aforementioned projections for insertion of protruding portions formed on additional support member, so that this member can be inserted and stored together with the holder in a storage position, in which both segments are shifted with respect to each in a circular direction to a position of maximum overlapping and minimum space occupied by the device.

U.S. Design Pat. No. 434,600, issued to Garcia et al., discloses an ornamental design for a coffee pot holder.

U.S. Pat. No. 4,078,839, issued to Chambers et al., discloses a carrying handle and lifting device for flower pots. A lifting and carrying device for flower pots is formed by a generally vertical main support post or bar with a pot supporting member at its lower end and a pair of gripping jaws actuated by a lifting and carrying handle pivotally secured to the upper end of the post. The jaw mechanism is formed by a fixed jaw on the post for engaging the upper rim of the pot on the outside surface and an inner jaw swingably mounted on the post and actuated by a linkage mechanism connected to the handle for engaging the upper rim of the pot on the inside surface. As the handle is lifted, the jaws grip the upper rim of the pot and the pot is lifted for carrying.

U.S. Pat. No. 4,038,914, issued to Crespo et al., discloses a device for use in separating coffee brewers which are in two screw-threaded portions. This invention is a tool for use in separating a coffee brewer of the type which includes a screw thread connected upper and lower portion and which tool comprises a socket sized to receive the bottom of the lower portion of the coffee brewer and means to secure the tool to a table, such as by suction cups which are fastened to the bottom of the tool.

U.S. Patent Application Publication No.: 2005/0006397, by Borhofen, discloses a self-releasing, heat insulating pan handle holder. A self-releasing pan-handle holder for thermally insulating a handle on pots and pans. The pan-handle holder is designed to receive the long handle on a port or pan. The pan-handle holder comprises an insulating sleeve having a sleeve axis with first and second complimentary sections and a lumen, which allows for closely receiving a pan-handle. The pan-handle holder further includes a biasing mechanism for holding the first and second complimentary sections apart. When the pan-handle holder is placed on a pot or pan-handle, it is squeezed tightly and held around the pan-handle to protect the user from heat in the handle. Typically, the component parts of the present pan-handle holder are made of a non-metallic thermal insulating material.

U.S. Pat. No. 6,517,037, issued to Munoz, discloses a stove-top pan holding apparatus. A stove-top pan holding apparatus for providing safer conditions around stoves for children. The stove-top pan holding apparatus includes a pan holder support member being adapted to securely fastened to a stove; and also includes a pan holder being adjustably fastened to the pan holder support member for holding a handle of a pan upon the stove; and further includes fastening members for fastening the pan holder to the pan holder support member.

The inventions heretofore known suffer from a number of disadvantages which include: being fixed, being unbalanced, being expensive, not being adjustable, not having removable parts, not being removable, and/or being difficult to use.

What is needed is a handle securing device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available handle securing devices. Accordingly, the present invention has been developed to provide a handle securing device for securing handles of pots and/or pans.

In one embodiment, there may be a handle securing device for securing handles of pots and/or pans, including: a base member; a first vertical barrier member, removably coupled to the base member and/or extending upwardly therefrom, and/or configured to restrict a rotation of a handle; a second vertical barrier member, removably coupled to the base member and/or extending upwardly therefrom substantially parallel to the first vertical barrier member, configured to restrict a rotation of a handle, and/or spaced a distance from the first vertical barrier member corresponding to a width of a handle so that a handle may be disposed between the first vertical barrier member and/or the second vertical barrier member; and/or an attachment mechanism, fixedly coupled to a bottom side of the base member, removably coupleable to a surface of stovetop.

In another embodiment, the attachment mechanism may include a suction cup. In still another embodiment, the first and/or second vertical barrier members may be substantially rigid. In yet another embodiment, the first and/or second vertical barrier members may be substantially curved. In still yet another embodiment, the first and/or second vertical barrier members may be substantially identical. In even another embodiment, the first vertical barrier member may be removably coupled to the base member at a first attachment port; and/or the second vertical barrier member may be removably coupled to the base member at a second attachment port. In even yet another embodiment, the handle securing device may include: a third vertical barrier member, removably coupleable to the first attachment port, and/or sized substantially different than the first vertical barrier member; and/or a fourth vertical barrier member, removably coupleable to the second attachment port, and/or sized substantially different than the second vertical barrier member.

In a further embodiment, there may be a handle securing device for securing handles of pots and/or pans, including: a base member; a first vertical barrier member, coupled to the base member and/or extending upwardly therefrom, and/or configured to restrict a rotation of a handle; a second vertical barrier member, coupled to the base member and/or extending upwardly therefrom substantially parallel to the first vertical barrier member, configured to restrict a rotation of a handle, and/or spaced a distance from the first vertical barrier member corresponding to a width of a handle so that a handle may be disposed between the first vertical barrier member and/or the second vertical barrier member; and/or an attachment mechanism, fixedly coupled to a bottom side of the base member, removably coupleable to a surface of a stovetop.

In still a further embodiment, the attachment mechanism may include a suction cup. In yet a further embodiment, the first and/or second vertical barrier members may be substantially rigid. In still yet a further embodiment, the first and/or second vertical barrier members may be substantially curved.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational view of a handle securing device, according to one embodiment of the invention;

FIG. 2 is a rear perspective view of a handle securing device, according to one embodiment of the invention;

FIG. 3 is a top plan view of a handle securing device, according to one embodiment of the invention; and

FIG. 4 is a bottom plan view of a handle securing device, according to one embodiment of the invention.

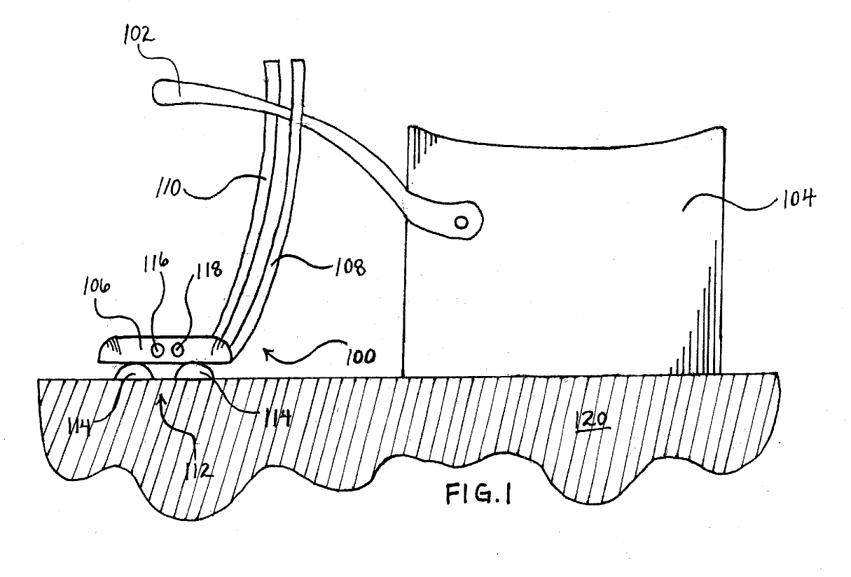

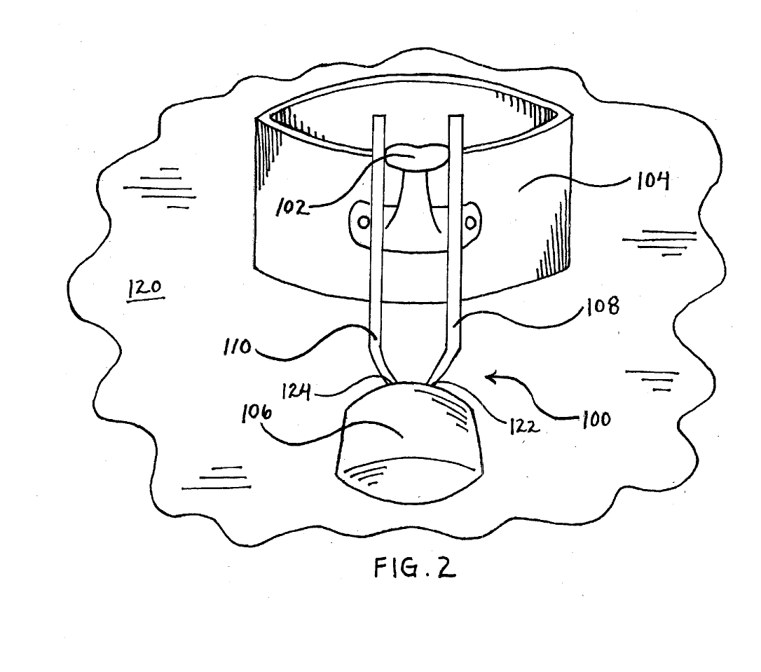

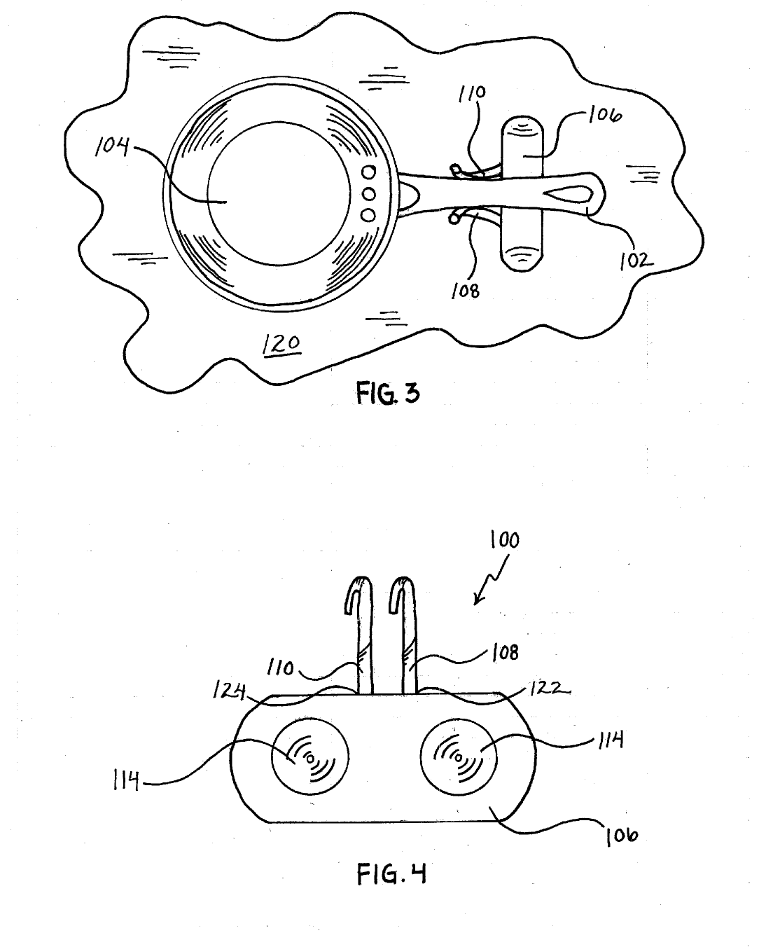

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Looking to the Figures, there is illustrated a handle securing device 100 for securing a handle 102 of a pot and/or pan 104 to a stovetop 120. As illustrated, the handle securing device 100 has a base member 106. The base member 106 is coupled to an attachment mechanism 112, which attaches the base member 106 to the stovetop 120.

As shown, the attachment mechanism 112 is a suction cup 114.

Also illustrated, a first vertical barrier member 108 and a second vertical barrier member 110 are coupled to the base member 106 at a first attachment port 122 and a second attachment port 124, respectively. The first vertical barrier member 108 and second vertical barrier member 110 are spaced so that a handle 102 may be disposed between the first vertical barrier member 108 and the second vertical barrier member 110. In addition, the first vertical barrier member 108 and the second vertical barrier member 110 may be fixably coupled and/or removably coupled to the base member 106. As shown, the first and second vertical barrier members 108, 110 are substantially curved and substantially identical. Advantageously, the first and second vertical barrier members 108, 110 may also be substantially rigid so as to restrict a rotation of a handle 102.

Additionally illustrated, the base member 106 has a plurality of attachment ports 116, 118, 122, 124 for attachment of vertical barrier members 108, 110 at different locations. There may also be a third vertical barrier member (not shown) and a fourth vertical barrier member (not shown) which are removably coupleable to the plurality of attachment ports 116, 118, 122, 124. The third and/or fourth vertical barrier members may also be sized substantially different than, and/or interchangeable with, the first and/or second vertical barrier members 108, 110, respectively.

Advantageously, in one embodiment, a user may select a base member 106, having an attachment mechanism 112, and attach the base member 106 to a stovetop 120 by engaging the base member 106 with the stovetop 120. There may be first vertical barrier member 108 and/or a second vertical barrier member 110 coupled to the base member 106. If there are no first and/or second vertical barrier members 108, 110 coupled to the base member 106, a user may select first and/or second vertical barrier members 108, 110 and couple them to the base member 106, such as by insertion into a first attachment port 122 and/or a second attachment port 124, respectively.

In another embodiment, a user may also select third vertical barrier member and/or a fourth vertical barrier member and couple the third vertical barrier member and/or the fourth vertical barrier member to a plurality of attachment ports 116, 118, 122, 124, as desired. Once a user has coupled the vertical barrier members 108, 110 to the base member 106, the user may dispose the handle 102 of a pot and/or pan 104 between the first vertical barrier member 108 and the second vertical barrier member 110. In addition, a user may position the handle securing device 100 at a location on the stovetop 120 so that the handle securing device 100 may secure a plurality of handles 102 of pots and/or pans 104 at the same time, such one handle 102 from each of two different pots and/or pans 104. When a user accidentally contacts the pot and/or pan 104 causing it to move and/or rotate, the handle 102 contacts a vertical barrier member 108, 110 which restricts movement and/or rotation of the pot and/or pan 104.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the handle securing device 100 is shown with two vertical barrier members 108, 110, the handle securing device 100 may have any number of vertical barrier members 108, 110, such as one, three, four, etc.

Also, although the vertical barrier members 108, 110 shown are substantially curved, the vertical barrier members 108, 110 may have any shape, such as L-shaped. Similarly, although the vertical barrier members 108, 110 are substantially identical, the vertical barrier members 108, 110 may have varying length so that the first vertical barrier member 108 is longer than the second vertical barrier member 110, and vice versa.

Also, although a suction cup 114 is illustrated by the Figures, the handle securing device 100 may have any attachment mechanism 112 known in the art for coupling to a surface of a stovetop 112. Some non-limiting examples of attachment mechanisms 112 include, but are not limited to: magnets, weights, adhesives, bolts, and clamps.

Additionally, although the Figures illustrate a single pot and/or pan 104, the handle securing device 100 may be positioned at a location on a stovetop 120 so that the handle securing device 100 may secure a plurality of handles 102 of pots and/or pans 104 at the same time. For example, the handle securing device 100 may secure one handle 102 from each of two different pots and/or pans 104 at the same time. As non-limiting examples, the handle may secure a plurality of handles 102 at the same time by disposing the handles 102 vertically, with one on top of the other, or by disposing the handles 102 horizontally side-by-side.

It is also envisioned that the base member 106 and/or the vertical barrier members 108, 110 may have any shape or size known in the art. For example, the base member 106 and/or the vertical barrier members 108, 110 may be: circular, rectangular, square, trapezoidal, oval, and any other shape known in the art. The base member 106 and/or the vertical barrier members 108, 110 may also be colored, such as blue, for example.

It is expected that there could be numerous variations of the design of this invention. For example, the base member 106 could be coupled to any number of vertical barrier members 108, 110 such as one, three, or four. In another example, the base member could have a plurality of attachment ports 116, 118, 122, 124, such as two, three, or four. Additionally, the attachment ports 116, 118, 122, 124 may be arranged on the base member 106 in any manner currently known in the art. Some non-limiting examples include: horizontal, and/or diagonal, and/or vertical, and so forth.

Finally, it is envisioned that the components of the device may be constructed of a variety of materials. Some non-limiting examples of materials that the handle securing device 100 may be constructed of include: metal, plastic, polyurethane, rubber, adhesive, and any combination thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A handle securing device for securing handles of pots and pans, comprising:
a) a base member;
b) a first vertical barrier member, removably coupled to the base member and extending upwardly therefrom, and configured to restrict a rotation of a handle;
c) a second vertical barrier member, removably coupled to the base member and extending upwardly therefrom, substantially parallel to the first vertical barrier member, configured to restrict a rotation of a handle, and wherein the second vertical barrier member is spaced a distance from the first vertical barrier member corresponding to a width of a handle so that a handle may be disposed between the first vertical barrier member and the second vertical barrier member; and
d) an attachment mechanism, fixedly coupled to a bottom side of the base member, removably coupleable to a surface of a stovetop.

2. The handle securing device of claim 1, wherein the attachment mechanism includes a suction cup.

3. The handle securing device of claim 2, wherein the first vertical barrier member and the second vertical barrier member are substantially rigid.

4. The handle securing device of claim 3, wherein the first vertical barrier member and the second vertical barrier member are substantially curved.

5. The handle securing device of claim 4, wherein the first vertical barrier member and the second vertical barrier member are substantially identical.

6. The handle securing device of claim 5, wherein:
a) the first vertical barrier member is removably coupled to the base member at a first attachment port; and
b) the second vertical barrier member is removably coupled to the base member at a second attachment port.

7. The handle securing device of claim 6, further comprising:
a) a third vertical barrier member, removably coupleable to the first attachment port, and sized substantially different than the first vertical barrier member; and
b) a fourth vertical barrier member, removably coupleable to the second attachment port, and sized substantially different than the second vertical barrier member.

8. A handle securing device for securing handles of pots and pans, comprising:
a) a base member;
b) a first vertical barrier member, coupled to the base member and extending upwardly therefrom, and configured to restrict a rotation of a handle;
c) a second vertical barrier member, coupled to the base member and extending upwardly therefrom substantially parallel to the first vertical barrier member, configured to restrict a rotation of a handle, and wherein the second vertical barrier member is spaced a distance from the first vertical barrier member corresponding to a width of a handle so that a handle may be disposed between the first vertical barrier member and the second vertical barrier member; and
d) an attachment mechanism, fixedly coupled to a bottom side of the base member, removably coupleable to a surface of a stovetop.

9. The handle securing device of claim 8, wherein the attachment mechanism includes a suction cup.

10. The handle securing device of claim 9, wherein the first vertical barrier member and the second vertical barrier member are substantially rigid.

11. The handle securing device of claim 10, wherein the first vertical barrier member and the second vertical barrier member are substantially curved.

12. A handle securing device for securing handles of pots and pans, consisting essentially of:
a) a base member;
b) a first vertical barrier member, removably coupled to the base member and extending upwardly therefrom, and configured to restrict a rotation of a handle;
c) a second vertical barrier member, removably coupled to the base member and extending upwardly therefrom substantially parallel to the first vertical barrier member, configured to restrict a rotation of a handle, and wherein the second vertical barrier member is spaced a distance from the first vertical barrier member corresponding to a width of a handle so that a handle may be disposed between the first vertical barrier member and the second vertical barrier member; and
d) an attachment mechanism, fixedly coupled to a bottom side of the base member, removably coupleable to a surface of a stovetop.

13. The handle securing device of claim 12, wherein the attachment mechanism includes a suction cup.

14. The handle securing device of claim 13, wherein the first vertical barrier member and the second vertical barrier member are substantially rigid.

15. The handle securing device of claim 14, wherein the first vertical barrier member and the second vertical barrier member are substantially curved.
